(19) United States
(12) Patent Application Publication
(10) Pub. No.: US 2003/0081708 A1
(43) Pub. Date: May 1, 2003

(54) Circuit configuration

(76) Inventors: Hans-Joachim Gelke, Zuerich (CH); Steffen Gappisch, Zuerich (CH); Stephan Koch, Zuerich (CH)

Correspondence Address: U.S. Philips Corporation, 580 White Plains Road, Tarrytown, NY, 10591, US

(21) Appl. No.: 10/274,237

(22) Filed: Oct. 18, 2002

(30) Foreign Application Priority Data
Oct. 23, 2001 (DE) 10152195.2

(51) Int. Cl. H04L 7/00

(52) U.S. Cl. 375/354

(57) ABSTRACT

Circuit configuration for signal transmission from a finite state machine that can be operated at a first clock rate to a finite state machine that can be operated at a second clock rate, the signal from the transmitting finite state machine being transferable through an asynchronous storage element and a synchronous storage element connected thereto, to the receiving finite state machine which is designed for transmitting a reset signal to the asynchronous storage element after the signal transmission.

The invention relates to a circuit configuration for signal transmission from a finite state machine that can be operated at a first clock rate to a finite state machine that can be operated at a second clock rate.

The expression ‘finite state machine’ here denotes in general a digital circuit, which can assume a limited number of states in dependence on input signals, conditions and events.

Because of the progressive miniaturization of semiconductor chips in silicon technology, it is possible to integrate several finite state machines, each representing an independent system, on a single chip. It is also becoming more and more important to choose the correct relationship between energy consumption and computing capacity. Many devices therefore have several finite state machines, which are operated at different clock rates. For example, in a mobile transceiver the digital speech processor (DSP) may run at a high clock rate, whereas a system controller, which undertakes the keyboard scanning among other things, may be operated at a lower clock rate. However, these systems running at different clock rates must be capable of communicating with each other and of transferring or exchanging signals. It is therefore necessary to synchronize the signals.

In communication between signals with different clock rates, there is a danger that a signal sent from the faster system is not recognized by the slower system because its sampling rate is too low. To remedy this, two synchronization stages are usually used between the finite state machines in known systems. However, each synchronization stage causes a delay and a loss of speed.

Systems that can be operated at different clock rates are already known. The problem then arises that it cannot be definitely predicted which of the two finite state machines is the faster. In these cases, synchronization stages must therefore be provided for both directions, so that the signal transfer can be executed with a handshaking method. This variant necessitates an increased construction cost and leads to a further loss of performance.

The invention accordingly has for its object to specify a circuit configuration for signal transmission between two asynchronous finite state machines which avoids the above disadvantages and is improved in terms of performance.

To achieve this object, in a circuit configuration of the kind mentioned in the opening paragraph, it is provided according to the invention that the signal can be transferred from the transmitting finite state machine through an asynchronous storage element and a synchronous storage element connected thereto, to the receiving finite state machine, which is designed so as to transmit a reset signal to the asynchronous storage element after the signal transmission.

The circuit configuration according to the invention presents the advantage that only a single synchronization stage is necessary. The signal is stored asynchronously in a storage element by the transmitting finite state machine, and reaches the receiving finite state machine through the synchronous storage element. It is a great advantage here that the signal can immediately be processed by the receiving finite state machine, while the asynchronous storage element is reset by a reset signal sent by the receiving finite state machine. Only a single synchronization stage is necessary, while the receiving finite state machine undertakes the second synchronization step immediately. Dispensing with the relatively costly handshaking method leads to a speed advantage. The signal transmission can be asynchronous (i.e. independent of the particular clock rates) in the circuit configuration according to the invention.

A still greater failure safety is achieved if an internal register is provided in the receiving finite state machine for the reset signal to be transmitted to the asynchronous storage element. This can effectively prevent a premature reset.

The asynchronous storage element in the circuit configuration according to the invention can appropriately be of the latch type. The storage element can thus present the states “0” or “1” between which switching can take place, as in a flip-flop. The storage element is reset each time by the reset signal sent by the receiving finite state machine.

According to the invention, the synchronous storage element can be operated at the clock rate of the receiving finite state machine. This storage element represents the first synchronization stage.

Developing the inventive idea, it may be provided in the circuit configuration according to the invention that the asynchronous storage element can be operated at the first or the second clock rate. This circuit is especially suitable for testing the synchronization.

In addition, the invention relates to an electronic device, especially a mobile telephone, Personal Digital Assistant (PDA), GPS system, or navigation system, which presents a circuit configuration of the kind described.

The invention will be further described with reference to examples of embodiments shown in the drawings to which, however, the invention is not restricted. The drawings are schematic representations, in which:

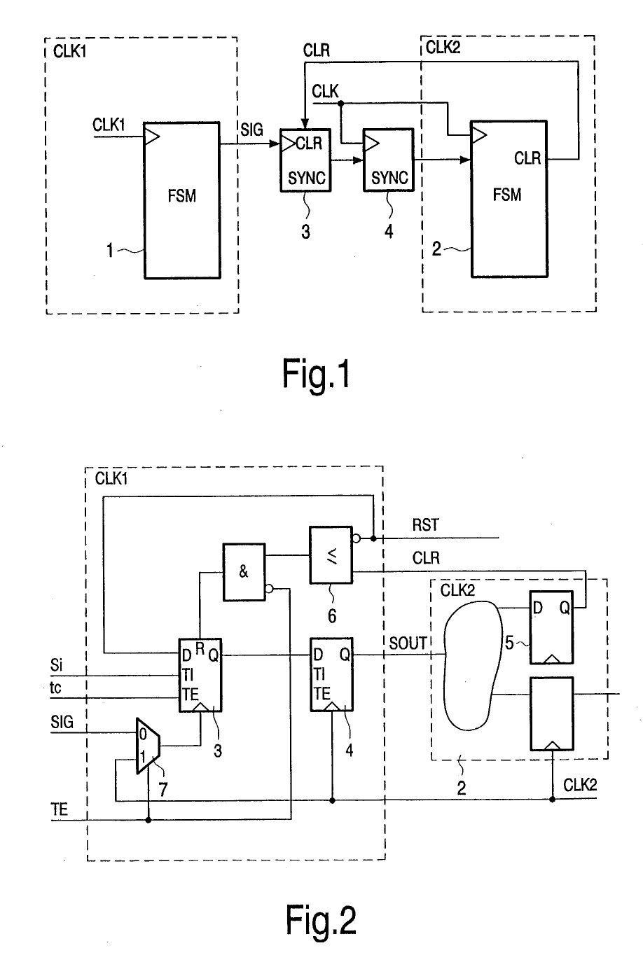

FIG. 1 shows a circuit configuration according to the invention, for signal transmission between two finite state machines with different clock rates

FIG. 2 shows a circuit configuration in which the clock rate of the asynchronous storage element can be switched over;

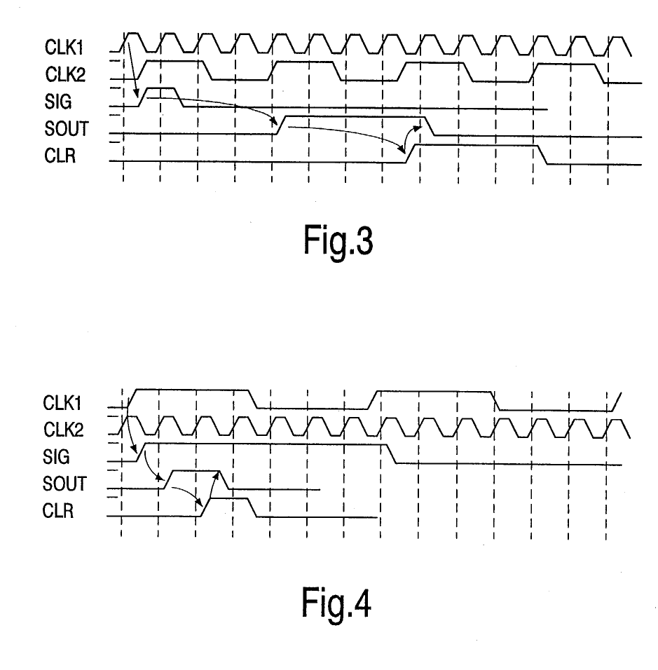

FIG. 3 shows the signal flow in the synchronization of a faster system with a slower system; and

FIG. 4 shows the signal flow in the synchronization of a slower system with a faster system.

The circuit configuration shown in FIG. 1 comprises a first finite state machine (FSM) 1 which is operated at the clock rate CLK 1. The broken line on the left side of FIG. 1 marks the entire part of the circuit configuration operating at the clock rate CLK1.

The signal is transferred from the first finite state machine 1 to the asynchronous storage element 3. The signal is stored in the asynchronous storage element 3 and goes from there to a synchronous storage element 4. The synchronous storage element 4 is operated at a second clock rate (CLK2, which may be higher or lower than the clock rate 1. The synchronous storage element 4 and the finite state machine 2 have the same clock rate (CLK2), i.e. they are synchronized with each other. The broken frame on the right side of FIG. 1 marks the part of the circuit configuration that runs at clock rate CLK2.

From the synchronous storage element 4, the signal goes to the finite state machine 2, which serves as the second synchronization step. The signal can be further processed immediately in the finite state machine 2, since no second external synchronization step is necessary. A loss of time from a handshaking method is thereby avoided. At the same time, the finite state machine 2 sends the reset signal (CLR) to the asynchronous storage element 3, which is reset thereby. After the reset, the asynchronous storage element 3 is once again available for signal transmission.

The circuit configuration shown in FIG. 1 enables a completely asynchronous operation, which is independent of the individual clock rates.

FIG. 2 shows an embodiment in which the clock rate of the asynchronous storage element can be switched over. Identical components have been given the same reference symbols as in FIG. 1.

The asynchronous storage element 3 is driven and switched by the signal SIG from a finite state machine not shown in FIG. 2. This signal is forwarded to the synchronous storage element 4 and synchronized there; the output signal SOUT from the synchronous storage element 4 is transferred to the finite state machine 2. The finite state machine 2 sends the reset signal CLR to the asynchronous storage element 3 to reset this, when its signal has been recognized by the finite state machine 2. The finite state machine 2 has a register 5 which is used as temporary storage for the reset signal CLR and which may be an internal or an external register. The register 5 prevents the asynchronous storage element 3 being prematurely reset in unstable states. The individual logic chips of the registers must be chosen such that the time delay caused by them is as small as possible.

To switch the asynchronous storage element 3 to a particular state after a reset, the signal RST is linked through an OR gate to the reset signal CLR. The input D of the asynchronous storage element 3 is connected to the signal RST, to enable the reset status of the asynchronous storage element 3 to be checked.

In order to test the synchronization of the circuit configuration, the clock rate of the asynchronous storage element 3 can be switched over to the clock rate CLK 2 by the signal TE through the gate 7.

FIG. 3 shows the signal flow in the synchronization of a faster system with a slower system. The individual signal flows are applied over the time axis. As can be seen in FIG. 3, the clock rate CLK 1 of the finite state machine 1 shown in the first line is higher than the clock rate CLK 2 of the finite state machine 2 shown in the second line. The signal transmission is initiated by the finite state machine 1, which sends the signal SIG shown in the third line via the asynchronous storage element 3 to the synchronous storage element 4. The synchronous storage element 4 operates at the clock rate CLK 2, so that the output signal SOUT of the synchronous storage element 4 shown in the fourth line is synchronized with the clock rate of the finite state machine FSM2. The signal SOUT presents a rising edge at the beginning of a new clock cycle of CLK2. This signal reaches the finite state machine 2, which in turn, at the beginning of the next clock cycle of CLK2, sends the CLR signal shown in the bottom line of FIG. 3 to reset the asynchronous storage element 3. Shortly afterwards, the signal SOUT is also reset once more.

Analogously, FIG. 4 shows the signal flow in the synchronization of a slower system with a faster system. In this embodiment, the clock rate CLK1 is lower than the clock rate CLK2. After the signal SIG shown in the third line has been activated by the finite state machine 1, the signal SIG is switched over, which in the manner described above, after a certain time has elapsed, leads to a rising edge of the signal SOUT shown in line 4. Analogously to the previous example, in the next cycle the reset signal CLR (bottom line) is activated by the finite state machine 2 and the signal SOUT is thereby reset again. The finite state machine 1 with the slower clock rate CLK1 is thus synchronized with the faster finite state machine 2.

The described circuit configuration is especially suitable for systems in which several clock rates are used, such as mobile transceivers, Personal Digital Assistants (PDAs), GPS systems, car navigation systems, and the like.

1. A circuit configuration for signal transmission from a finite state machine that can be operated at a first clock rate to a finite state machine that can be operated at a second clock rate, characterized in that the signal from the transmitting finite state machine (1) can be transmitted through an asynchronous storage element (3) and a synchronous storage element (4) connected thereto, to the receiving finite state machine (2) which is designed so as to transmit a reset signal to the asynchronous storage element (3) after the signal transmission.

2. A circuit configuration as claimed in claim 1, characterized in that an internal register (5) is provided in the receiving finite state machine (2) for the reset signal that is to be transmitted to the asynchronous storage element (3).

3. A circuit configuration as claimed in claim 1 or 2, characterized in that the asynchronous storage element (3) is of the latch type.

4. A circuit configuration as claimed in any one of the preceding claims, characterized in that the synchronous storage element (4) can be operated at the clock rate of the receiving finite state machine (2).

5. A circuit configuration as claimed in any one of the preceding claims, characterized in that the asynchronous storage element (3) can be operated at the first or the second clock rate.

6. An electronic device, especially a mobile telephone, Personal Digital Assistant (PDA), GPS system, or navigation system, characterized in that it comprises a circuit configuration as claimed in any one of the claims 1 to 5.
